(19) United States
(12) Patent Application Publication
(10) Pub. No.: US 2010/0330429 A1
(43) Pub. Date: Dec. 30, 2010

(54) POSITIVE ELECTRODE ACTIVE MATERIAL AND LITHIUM SECONDARY BATTERY

(75) Inventors: Yukinobu YURA, Nagoya-City (JP); Nobuyuki Kobayashi, Nagoya-City (JP); Tsutomu Nanataki, Toyoake-city (JP); Kazuyuki Kaigawa, Kitanagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/819,465

(22) Filed: Jun. 21, 2010

(51) Int. Cl. H01M 4/50; H01M 4/90

(52) U.S. Cl. 429/224; 252/182.1; 428/402

(57) ABSTRACT

A positive electrode active material having an average from 1 μm or lager to smaller than 5 μm and containing a large number of crystal grains being composed of lithium manganate of spinel structure containing lithium and manganese as constituent elements, whose crystallite size is 500 to 1,500 nm in powder X-ray diffraction pattern, and whose value of a lattice strain (η) of 0.05×10⁻³ to 0.9×10⁻³ in powder X-ray diffraction pattern, and whose D₅₀/D_{BET} ratio is 1 to 4 wherein the D₅₀ (μm) is the median diameter of the positive electrode active material and the D_{BET} (μm) is calculated from the BET specific surface area by using the following general formula (1).

D_{BET}=6/(d×S) (1)

[Wherein d is the true density (g/cm³) of the positive electrode active material powder and S is BET specific surface area (m²/g) in the general formula (1).]

### TECHNICAL FIELD

The present invention relates to a positive electrode active material and a lithium secondary battery. More particularly, the present invention relates to a positive electrode active material usable for production of a lithium secondary battery superior in high-temperature cycle property as well as in rate property and being superior in coating property, and a lithium secondary battery superior in high-temperature cycle property as well as in rate property and high in productivity.

### BACKGROUND ART

In recent years, portable electronic devices such as mobile phone, VTR, laptop PC and the like have become smaller and lighter at an accelerated pace. Lithium secondary battery is in use as an electric source of such devices. In general, lithium secondary battery has a high energy density and a high unit-cell voltage of about 4 V; therefore, it is being used not only as an electric source of portable electronic devices but also as an electric source for driving the motor of electric vehicle or hybrid electric vehicle.

As the positive electrode active material of lithium secondary battery, there are known lithium cobaltate of layered rock salt structure, lithium nickelate of layered rock salt structure, lithium manganate of spinel structure, etc. Lithium cobaltate of layered rock salt structure is unstable in supply because the reserve of cobalt is small and the cobalt-producing regions are unevenly distributed. Also, lithium nickelate of layered rock salt structure has a problem of unstable structure in charging condition.

Lithium manganate of spinel structure, as compared with lithium cobaltate of layered rock salt structure and lithium nickelate of layered rock salt structure, is high in safety as well as rate property and low in cost; but it has a problem of inferior in high-temperature cycle property. As to the reason therefor, it is known that Mn ion dissolves into the electrolytic solution of battery during charge and discharge to change the lithium manganate crystal structure. Various investigations have been made in order to improve the high-temperature cycle property (see, for example, Patent Documents 1 to 4).

In Patent Document 1 is disclosed a positive electrode active material composed of a powder of lithium manganate particles having an average primary particle diameter of 3 to 20 μm, an average secondary particle diameter of 2.5 to 40 μm and a ratio of the average primary particle diameter and the secondary particle diameter (i.e. the average primary particle diameter/the average secondary particle diameter), of 0.5 to 1.2. Also, in Patent Document 2 is disclosed a positive electrode active material using a powder of trimanganese tetroxide particles of polyhedral shape (having a triangular, tetragonal or hexagonal plane), having an average primary particle diameter of 3 to 15 μm and containing NaO in an amount of 0.02 wt. % or less and S in an amount of 0.01 wt. % or less.

Further, in Patent Document 3 is disclosed a positive electrode active material using lithium-manganese compound oxide which has an average particle diameter of 0.1 to 50 μm and a BET specific surface area of 0.1 to 2 m²/g, and is obtained by grinding a lithium-manganese compound oxide represented by LiₓMn_{2-y}Me_{y}O_{4-z} (Me is Al, Zr or Zn; x is 0<x<2; y is 0≦y<0.6; and z is 0≦z≦2) and subsequently heating the ground material at 300 to 800° C. Also, in Patent Document 4 is disclosed a positive electrode active material which has an average particle diameter of 0.1 to 50 μm, an n value by Rosin-Rammler's formula of 3.5 or more, a BET specific surface area of 0.1 to 1.5 m²/g, and is used lithium-manganese compound oxide represented by LiₓMn_{2-y}Me_{y}O_{4-z} (Me is a metal element or transition metal element having an atomic number of 11 or larger, other than Mn; x is 0<x<2; y is 0≦y<0.6; and z is 0≦z<2).

### [Prior Art Documents]

### [Patent Documents]

Patent Document 1: JP-A-2003-272629

Patent Document 2: JP-B-4305629

Patent Document 3: JP-A-2002-226213

Patent Document 4: JP-A-2001-122626

### SUMMARY OF THE INVENTION

In the positive electrode active materials of Patent Documents 1 to 4, the improvement in high-temperature cycle property was attained. However, in these active materials, particles having large diameter and small specific surface area are used in order to suppress the dissolution of Mn ion into electrolytic solution. In the case of using the particles having small specific surface area, the area in which the de-intercalation and intercalation of Li is possible is small. Moreover, in the case of using the particles having large diameter or aggregated the particles, the diffusion distance in solid of Li ion is long. Therefore, there is a fear that the maintenance of sufficient capacity is impossible (that is, there is a reduction in rate property).

The present invention has been made in view of the above viewpoints. The theme of the present invention is to provide a positive electrode active material usable for production of a lithium secondary battery superior in high-temperature cycle property as well as in rate property and being superior in coating property.

The present inventors made an extensive study in order to attain the above theme. As a result, it was found that, by making a large number of crystal grains which are composed of lithium manganese of spinel structure, which have an average primary particle diameter of from 1 μm or larger to smaller than 5 μm, which are highly crystalline contained, and by having the a D₅₀/D_{BET} ratio (D₅₀: median diameter, D_{BET}: calculated from a given mathematical expression) of 1 to 4, there can be obtained a positive electrode active material usable for production of a lithium secondary battery superior in high-temperature cycle property as well as in rate property and being superior in coating property.

The present invention provides a positive electrode active material and a lithium secondary battery, both shown below.

[1] A positive electrode active material containing a large number of crystal grains which are composed of lithium manganate of spinel structure containing lithium and manganese as the constituent elements, which have an average primary particle diameter of from 1 μm or larger to smaller than 5 μm, which have a crystallite size of 500 to 1,500 nm in powder X-ray diffraction pattern, which have a value of the lattice strain (η) of 0.05×10⁻³ to 0.9×10⁻³ in powder X-ray diffraction pattern, and having a D₅₀/D_{BET} ratio of 1 to 4 wherein the D₅₀ (μm) is the median diameter of the positive electrode active material and the D_{BET} (μm) is calculated from the BET specific surface area of the positive electrode active material by using the following general formula (1).

D_{BET}=6/(d×S) (1)

[Wherein d is the true density (g/cm³) of the positive electrode active material powder and S is BET specific surface area (m²/g) in the general formula (1).]
[2] A positive electrode active material according to [1], wherein the crystal grains contain single particles by 40 areal % or more.
[3] A positive electrode active material according to [1], wherein the crystal grains contain primary particles of non-octahedral shape by 70 areal % or more.
[4] A positive electrode active material according to [2], wherein the crystal grains contain primary particles of non-octahedral shape by 70 areal % or more.
[5] A positive electrode active material according to [1], which further contains a bismuth compound containing bismuth.
[6] A positive electrode active material according to [1], which further contains a zirconium compound containing zirconium.
[7] A positive electrode active material according to [5], which further contains a zirconium compound containing zirconium.
[8] A lithium secondary battery which has an electrode body comprising a positive electrode containing a positive electrode active material according to [1] and a negative electrode containing a negative electrode active material.
[9] A lithium secondary battery which has an electrode body comprising a positive electrode containing a positive electrode active material according to [2] and a negative electrode containing a negative electrode active material.
[10] A lithium secondary battery which has an electrode body comprising a positive electrode containing a positive electrode active material according to [3] and a negative electrode containing a negative electrode active material.
[11] A lithium secondary battery which has an electrode body comprising a positive electrode containing a positive electrode active material according to [4] and a negative electrode containing a negative electrode active material.

The positive electrode active material of the present invention can show such an effect that it is usable for production of a lithium secondary battery superior in high-temperature cycle property as well as in rate property and is superior in coating property.

The lithium secondary battery of the present invention can show such an effect that it is superior in high-temperature cycle property as well as in rate property and is high in productivity.

### BRIEF DESCRIPTION OF THE DRAWINGS

FIG. 1 is an electron micrograph showing an example of the positive electrode active material of the present invention.

FIG. 2A is an electron micrograph showing an example of the primary particle of octahedral shape.

FIG. 2B is an electron micrograph showing other example of the primary particle of octahedral shape.

FIG. 2C is an electron micrograph showing still other example of the primary particle of octahedral shape.

FIG. 2D is an electron micrograph showing still other example of the primary particle of octahedral shape.

FIG. 2E is an electron micrograph showing still other example of the primary particle of octahedral shape.

FIG. 3A is an electron micrograph showing an example of the primary particle of non-octahedral shape.

FIG. 3B is an electron micrograph showing other example of the primary particle of non-octahedral shape.

FIG. 3C is an electron micrograph showing still other example of the primary particle of non-octahedral shape.

FIG. 3D is an electron micrograph showing still other example of the primary particle of non-octahedral shape.

FIG. 3E is an electron micrograph showing still other example of the primary particle of non-octahedral shape.

FIG. 3F is an electron micrograph showing still other example of the primary particle of non-octahedral shape.

FIG. 4 is an electron micrograph showing an example of the section of single particle.

FIG. 5 is an electron micrograph showing an example of the section of polycrystalline particle.

FIG. 6 is a schematic sectional view showing an embodiment of the lithium secondary battery of the present invention.

FIG. 7 is a schematic view showing an example of the electrode body constituting other embodiment of the lithium secondary battery of the present invention.

### MODE FOR CARRYING OUT THE INVENTION

The embodiment of the present invention is described below. However, the present invention is in no way restricted to the following embodiment. It should be construed that appropriate changes, improvements, etc. can be added to the following embodiment based on the ordinary knowledge possessed by those skilled in the art as long as there is no deviation from the gist of the present invention and that the resulting embodiments as well fall in the scope of the present invention.

In the present Specification; the expression “crystal grains” refers to all constituent particles such as polycrystalline particles, aggregated particles, single particles and the like (that is, all the particles constituting the whole powder). Also, the expression “primary particles” refers to smallest unit particles which can be clearly distinguishable from other particles, of the particles constituting the powder, and specifically refers to not only particles constituting single particles but also particles constituting polycrystalline particles and aggregated particles. Further, the expression “single particles” refers to each crystal grain which is present independently, of the crystal grains contained in the large number of crystal grains; that is, it refers to crystal grains which are not forming polycrystalline particles or aggregated particles.

### I. Positive Electrode Active Material

The positive electrode active material contains a large number of crystal grains which are composed of lithium manganate of spinel structure containing lithium and manganese as the constituent elements, which have an average primary particle diameter of from 1 μm or larger to smaller than 5 μm, which have a crystallite size of 500 to 1,500 nm in powder X-ray diffraction pattern, which have a value of the lattice strain (η) of 0.05×10⁻³ to 0.9×10⁻³ in powder X-ray diffraction pattern. Moreover, the positive electrode active material has a D₅₀/D_{BET} ratio of 1 to 4 wherein the D₅₀ (μm) is the median diameter of the positive electrode active material and the D_{BET} (μm) is calculated from the BET specific surface area of the positive electrode active material by using the following general formula (1).

D_{BET}=6/(d×S) (1)

[Wherein d is the true density (g/cm³) of the positive electrode active material powder and S is BET specific surface area (m²/g) in the general formula (1).]

It is not known exactly why the rate property of the lithium secondary battery becomes superior with improving its high-temperature cycle property by using the positive electrode active material of the present invention. The reason therefor is presumed as follows. The crystal grains of lithium manganate of spinel structure are so higher cycle property at high temperatures as highly crystalline, that is, larger in crystallite size and smaller in lattice strain. However, such crystal grains are generally primary particles of nearly octahedral shape constituted by stable crystal faces, or secondary particles formed by aggregating or bonding thereof. In the case of primary particles, the stable crystal face forming an octahedron is a (111) face, which is a close-packed plane of oxygen atoms. This crystal face effectively suppresses the dissolution of Mn in charge-discharge cycle but, on the other hand, is considered to suppress the intercalation and de-intercalation of Li during charge and discharge. Also, in the case of secondary particles, the presence of grain boundaries therein hinders the diffusion of Li ion. Thereby, while there is an improvement in high-temperature cycle property, there is a reduction in rate property in some cases.

In the positive electrode active material of the present invention, the crystal grains have a small average primary particle diameter of from 1 μm or larger to smaller than 5 μm, whereby the diffusion distance in solid of Li ion is short. Also, D₅₀/D_{BET} ratio is 1 to 4, whereby agglomeration of particles is low and the diffusion distance in solid of Li ion is shorter. Further, the crystal grains are highly crystalline (i.e. lattice defects therein are low), whereby the diffusion of Li ion is hardly hindered by the lattice defects. Also, the crystal grains contain many single particles, whereby the diffusion of Li ion is hardly hindered by the grain boundaries. Further, the crystal grains are highly crystalline grains having a (111) face on the surfaces, whereby the dissolution of Mn ion into electrolytic solution is suppressed; moreover, the crystal grains contain primary particles having a non-octahedral shape, whereby the crystal faces in which the intercalation and de-intercalation of Li is easy are exposed at the surfaces. Accordingly, it is presumed that the positive electrode active material of the present invention can be usable for production of a lithium secondary battery improved in high-temperature cycle property and superior in rate property.

Furthermore, the positive electrode active material according to the present invention can have such an effect that the coating property becomes superior, in addition to the above-mentioned advantages, because the crystal grains have a small average primary particle diameter of from 1 μm or larger to smaller than 5 μm and D₅₀/D_{BET} ratio is 1 to 4. This is particularly striking when the areal proportion of single particles contained in the crystal grains is as high as 40 areal % or more. The coating property is superior, whereby preparation of sheet-shaped positive electrode in production of lithium secondary battery is easy, leading to high productivity of lithium secondary battery.

### 1. Crystal Grains

The crystal grains are composed of lithium manganate of spinel structure containing lithium and manganese as the constituent elements, have an average primary particle diameter of from 1 μm or larger to smaller than 5 μm, have a crystallite size of 500 to 1,500 nm in powder X-ray diffraction pattern, and have a value of the lattice strain (η) of 0.05×10⁻³ to 0.9×10⁻³ in powder X-ray diffraction pattern. Also, the crystal grains preferably contain single particles by 40 areal % or more. Further, the crystal grains more preferably contain primary particles having a non-octahedral shape by 70 areal % or more.

### (Lithium Manganate)

The crystal grains are composed of lithium manganate of spinel structure containing lithium and manganese as the constituent elements. The chemical formula of lithium manganate is ordinarily represented by LiMn₂O₄. The crystal grains are not constituted only by the lithium manganate of the above chemical formula but also may be constituted by, for example, the lithium manganate represented by the following general formula (3) as long as it has a spinel structure.

LiMₓMn₂₋ₓO₄ (3)

In the general formula (3), M is at least one kind of substituting element selected from the group consisting of Li, Fe, Ni, Cu, Mg, Zn, Al, Co, Cr, Si, Sn, P, V, Sb, Nb, Ta, Mo and W, and at least two kinds of substituting elements including Ti, Zr and Ce additionally; and X is the substituting number of the substituting element M. Li becomes +mono-valent ion; Fe, Mn, Ni, Cu, Mg and Zn each become +bi-valent ion; B, Al, Co and Cr each become +tri-valent ion; Si, Ti, Sn, Zr and Ce each become +tetra-valent ion; P, V, Sb, Nb and Ta each become +penta-valent ion; Mo and W each become +hexa-valent ion; and all these elements are present theoretically in LiMn₂O₄ in the form of solid solution. Incidentally, Co and Sn may take +bi-valency; Fe, Sb and Ti may take +tri-valency; Mn may take +tri- and +tetra-valencies; and Cr may take +tetra- and +hexa-valencies. Therefore, the substituting element M may be present in a state of mixed valencies. As to the oxygen atom, its amount need not necessarily be as shown in the above chemical formula and may be insufficient or excessive as long as the required crystal structure is maintained.

When Mn is substituted by Li (Li is excessive), the chemical formula of lithium manganate becomes Li₍₁₊ₓ₎Mn₍₂₋ₓ₎O₄. Incidentally, x is preferably 0.05 to 0.15. When x is smaller than 0.05, the improvement in high-temperature cycle property caused by the substitution of Mn by Li may be insufficient.

When Mn is substituted by a substituting element M other than Li, the Li/Mn ratio becomes 1/(2−x), that is, Li/Mn ratio>0.5. When lithium manganate satisfying the relation of Li/Mn>0.5 is used, as compared with when lithium manganate of the chemical formula represented by LiMn₂O₄ is used, the crystal structure is more stabilized, whereby a lithium secondary battery superior in higher-temperature cycle property can be produced.

The crystal grains may be grains composed of lithium manganate in which 25 to 55 mol % of the total Mn is substituted by Ni, Co, Fe, Cu, Cr or the like, such as LiNi_{0.5}Mn_{1.5}O₄. The positive electrode active material using such a substitution type lithium manganate can be manufactured a lithium secondary battery which is improved in high-temperature cycle property and superior in rate property, and further has a high charge-discharge potential and a high energy density. Therefore, it can produce, a so-called lithium secondary battery having an electromotive force of 5 V level.

### (Average Primary Particle Diameter)

The average primary particle diameter of the crystal grains is from 1 μm or larger to smaller than 5 μm, preferably 1 to 4.5 μm. When the average primary particle diameter is not within this range, in addition to the coating property is inferior, the rate property and the high-temperature cycle property may be deteriorated. The reason for deteriorating the high-temperature cycle property is uncertain, but is considered to be that, when the average primary particle diameter is smaller than 1 μm, Mn ion dissolves into electrolytic solution easily. Meanwhile, when the average primary particle diameter is 5 μm or lager, the rate property may be deteriorated. Incidentally, the average primary particle diameter is a value specified as follows.

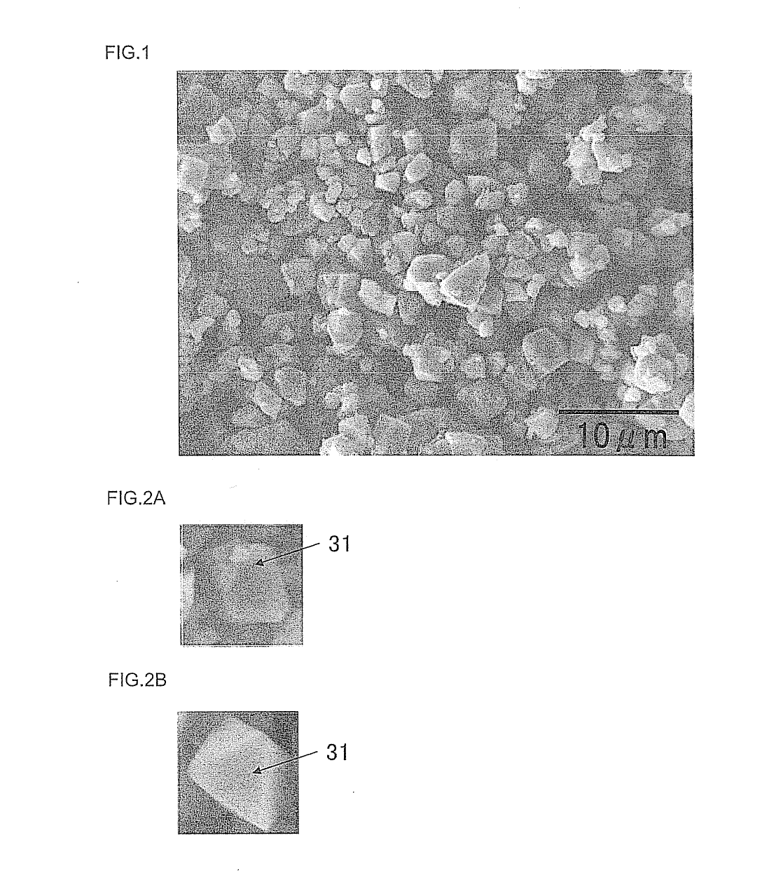

First, a positive electrode active material powder is placed on a carbon tape so that there is no piling of particles, and Au is sputtered thereon in a thickness of about 10 nm using an ion sputtering apparatus (“JFC-1500” (trade name), a product of JEOL Ltd.). Then, the secondary electron image of primary particles is taken, using a scanning electron microscope (“JSM-6390” (trade name), a product of JEOL Ltd.), at such a magnification (e.g. a 1,000 to 10,000 magnification) that 20 to 50 primary particles are observed in the visual field. Here, there is calculated the average of the maximum diameter of the particle having been obstructed part not hidden by other particles and the largest diameter of the diameters at right angles to the above maximum diameter, and the average is taken as the particle diameter (μm) of primary particles. The average primary particle diameter is calculated by using the average of the particle diameters of all primary particles excluding the uncalculable particles having been obstructed by other particles, of the image of the electron microscope. Incidentally, as to the particle diameter (μm) of the primary particles, not only the primary particles constituting single particles, but also the primary particles constituting polycrystalline particles and aggregated particles are measured to use for the calculation of the average primary particle diameter. In FIG. 1 is shown an electron micrograph of an example of the positive electrode active material of the present invention.

### (Crystallite Size)

The crystallite size in the powder X-ray diffraction pattern of crystal grains is 500 to 1,500 nm, more preferably 500 to 1,300 nm. When the crystallite size is not within this range, the rate property and the high-temperature cycle property may be deteriorated.

### (Lattice Strain (η))

Moreover, the value of the lattice strain (η) in powder X-ray diffraction pattern of crystal grains is preferably 0.05×10⁻³ to 0.9×10⁻³, more preferably 0.05×10⁻³ to 0.85×10⁻³. When the value of the lattice strain (η) is not within this range, the rate property or the high-temperature cycle property may be deteriorated. When the value of the lattice strain (η) is larger than 0.9×10⁻³, the high-temperature cycle property may be deteriorated. Incidentally, the crystallite size and the value of the lattice strain (η) can be calculated by using the following mathematical expression (2).

β cos θ=λ/D+2π sin θ (2)

[Wherein β is a integrated full width at half maximum (rad); θ is a diffraction angle (°); λ is a wavelength (\acute{Å}) of X-ray; and D is a crystallite size (\acute{Å}) in the expression (2).]

More specifically, the value of the lattice strain (η) can be calculated by analyzing the diffraction image of powder X-ray diffraction pattern with an analytical software “TOPAS”, according to the WPPD (Whole Powder Pattern Decomposition) method. Incidentally, the powder X-ray diffraction pattern can be measured using, for example, “D8 ADVANCE” (a product of Bruker AXS).

### (Single Particles)

The large number of crystal grains contained in the positive electrode active material of the present invention preferably contain single particles by 40 areal % or more. That is, the areal proportion of the single particles contained in the large number of crystal grains is preferably 40 areal % or more. When the areal proportion of the single crystals is less than 40 areal %, the amount of secondary particles such as polycrystalline particles, aggregated particles or the like is relatively large; thereby, the diffusion of Li ion is hindered at the boundaries of secondary particles, which may cause deterioration in rate property.

The areal proportion of the single particles contained in the large number of crystal grains can be determined by the following method. First, a positive electrode active material is mixed with a conductive resin (“Technovit 5000” (trade name), a product of Kulzer), followed by curing. Then, the cured material is subjected to mechanical polishing and then ion-polishing using a cross section polisher (“SM-09010” (trade name), a product of JEOL Ltd.). Thereafter, the back-scattered electron image of the resultant is taken, using a scanning electron microscope (“ULTRA 55” (trade name), a product of ZEISS), at such a magnification (e.g. a 1,000 to 10,000 magnification) that 20 to 50 primary particles are observed, and the cross section of the positive electrode active material is observed.

In the back-scattered electron image, when the crystal orientation is different, the contrast differs owing to channeling effect. Therefore, when a grain boundary part is present in a crystal grain being observed, the grain boundary part becomes clear or unclear by slightly changing the observed orientation of sample (the inclination of sample). Utilizing this behavior, the presence of grain boundary part can be confirmed; thereby, there can be identified whether or not a crystal grain is a single particle, a polycrystalline particle formed by connection of primary particles of different crystal orientations or an aggregated particle.

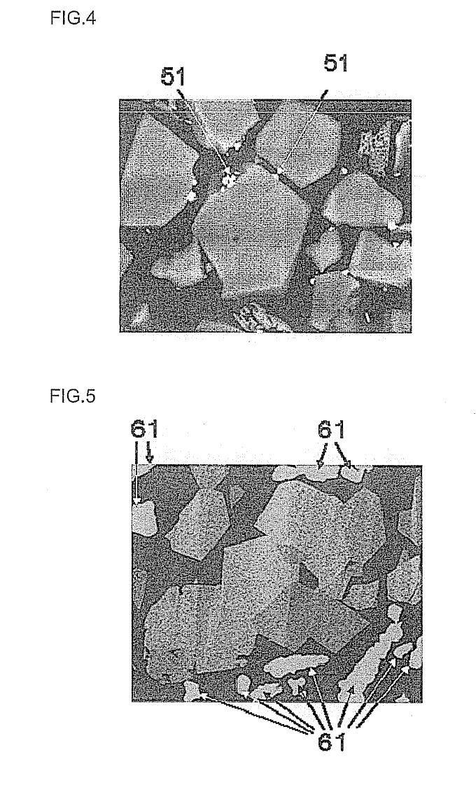

Incidentally, as shown in FIG. 4, there is also observed a particle having microparticles 51 adhered to the surface. Even when a particle has microparticles 51 strikingly smaller (e.g. about 0.01 to 0.5 μm) than the diameter of the particle adhered to the surface, the part of the particle to which the microparticles adhere is slight and accordingly there is no influence on rate property and durability. Therefore, such a particle having microparticles 51 adhered to the surface can be regarded substantially as single particle.

Specifically explaining, when the total length of all adhesion parts of a particle to which microparticles adhere is ⅕ or smaller relative to the round length of that particle estimated from the back-scattered electron image by using an image edit software (“Image-PRO” (trade name), a product of Media Cybernetics), the particle to which microparticles adhere is regarded as single particle. The areal proportion of single particles is calculated by measuring the area (B) occupied by all identifiable crystal grains and the area (b) occupied by all single particles each identified by as single particle, using the above-mentioned image edit software and subsequently substituting them into a formula of (b/B)×100. Here, each white particle 61 shown in FIG. 5 is a Cu powder contained in the above-mentioned conductive resin. Therefore it is not regarded as object for evaluation. Whether or not it is a Cu powder, can be judged by an elemental analysis using EDS (“Ultra Dry” (trade name), a product of Thermo Fisher SCIENTIFIC) equipped with the above-mentioned scanning electron microscope.

### (Primary Particle of Non-Octahedral Shape)

The crystal grains preferably contain primary particles of non-octahedral shape by 70 areal % or more, more preferably by 80 to 90 areal %. When the areal proportion of the primary particles of non-octahedral shape is less than 70 areal %, the rate property may be deteriorated. The method for measuring the proportion of the primary particles of non-octahedral shape is described below.

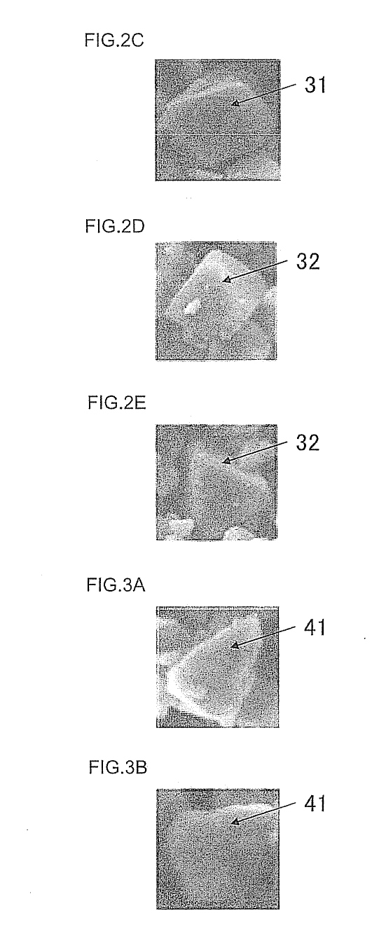

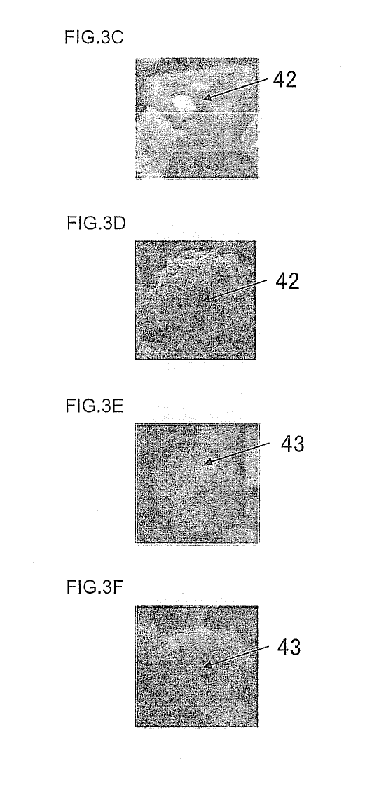

First, explanation is made on “primary particles of non-octahedral shape”. In each of FIGS. 2A to 2E is shown an electron micrograph of an example of the primary particle of octahedral shape. The primary particle of octahedral shape includes not only primary particles 31 of octahedral shape (see FIGS. 2A to 2C) but also partly chipped primary particles 32 (see FIGS. 2D to 2E). Meanwhile, in each of FIGS. 3A to 3F is shown an electron micrograph showing an example of the primary particle of non-octahedral shape. The primary particle of non-octahedral shape includes not only primary particles 41 clearly not having an octahedral shape (see FIGS. 3A to 3B) but also apex-chipped single particles 42 (see FIGS. 3C to 3D) and roundish primary particles 43 (see FIGS. 3E to 3F). Here, as to the apex-chipped primary particles 42, an apex is confirmed according to the following method and, when the apex has been confirmed, such primary particles are regarded to belong to primary particles of octahedral shape.

First, of the four ridge lines constituting an apex, the ridge lines which can be seen are extended to draw an imaginary apex (as necessary, new ridge lines are drawn). Next, the longest ridge line is selected of the ridge lines (excluding the newly added imaginary ridge lines). Lastly, for the longest ridge line, when the length of the imaginary ridge line is one fifth or smaller as compared with the length of the actual ridge line, the virtual apex is considered as apex.

Next, explanation is made on the method for measurement of “the proportion of the primary particles of non-octahedral shape”. The area (A) occupied by all the primary particles whose particle diameters and shapes can be evaluated and the area (a) occupied by the primary particles of non-octahedral shape are measured using an image edit software (photoshop (trade name), a product of Adobe); they are substituted into an expression (a/A)×100; thereby, the proportion can be calculated.

### 2. Positive Electrode Active Material

The positive electrode active material of the present invention preferably contains further a bismuth compound containing bismuth. It is presumed that the effect of improving the high-temperature cycle property can be attained since the dissolution of Mn from the surface of crystal grains is suppressed by making bismuth compound contained therein. Incidentally, the presence of the bismuth compound can be confirmed by using, for example, an electron microscope (“JSM-6390” (trade name), a product of JEOL Ltd.).

The bismuth compound includes, for example, bismuth oxide and a compound of bismuth and manganese. A compound of bismuth and manganese is preferred. As the compound of bismuth and manganese, there can be specifically mentioned compounds represented by chemical formulas of Bi₂Mn₄O₁₀ and Bi₁₂MnO₂₀. Of these, a compound represented by a chemical formula of Bi₂Mn₄O₁₀ is preferred particularly. Incidentally, the bismuth compound can be identified by X-ray diffraction measurement (hereinafter, this is referred to also as “XRD”) or by electron probe microanalysis (hereinafter, this is referred to also as “EPMA”).

The proportion of bismuth contained in the bismuth compound is preferably 10 ppm to 5 mass %, more preferably 10 ppm to 1 mass %, relative to the manganese contained in the lithium manganate. When the proportion is smaller than 10 ppm, the cycle property at high temperatures may be deteriorated. Meanwhile, when the proportion is larger than 5 mass %, the initial capacity may be deteriorated. Incidentally, the proportion of bismuth can be obtained by quantitatively determining lithium, manganese and bismuth using an ICP (inductively coupled plasma) optical emission spectrometer (“ULTIMA 2” (trade name), a product of HORIBA, Ltd.) and making calculation based on the results of the determination.

The positive electrode active material of the present invention preferably contains further a zirconium compound containing zirconium. It is presumed that the effect of improving the high-temperature cycle property can be attained since the dissolution of Mn from the surface of crystal grains is suppressed by making zirconium compound contained therein. Incidentally, the presence of the zirconium compound can be confirmed by using, for example, EPMA.

The zirconium compound includes, for example, zirconium oxide. There can be specifically mentioned a zirconium compound represented by a chemical formula of ZrO₂. Incidentally, the zirconium compound can be identified by using, for example, EPMA.

The proportion of zirconium contained in the zirconium compound is preferably 10 to 300 ppm, more preferably 100 to 300 ppm, relative to the manganese contained in the lithium manganate. When the proportion is smaller than 10 ppm, the cycle property at high temperatures may be deteriorated. Meanwhile, when the proportion is larger than 300 ppm, the initial capacity may be deteriorated. Incidentally, the proportion of zirconium can be obtained by quantitatively determining lithium, manganese and zirconium using an ICP optical emission spectrometer and making calculation based on the results of the determination.

### (Manufacturing Method)

As to the Manufacturing method of the positive electrode active material of the present invention, there is no particular restriction, and there is the following method, for example. First, there is prepared a mixed powder containing a lithium compound and a manganese compound.

As the lithium compound, there can be mentioned, for example, Li₂CO₃, LiNO₃, LiOH, Li₂O₂, LiO₂ and CH₃COOLi. As the manganese compound, there can be mentioned, for example, MnO₂, MnO, Mn₂O₃, Mn₃O₄, MnCO₃ and MnOOH. When Mn is substituted by a substituting element other than Li, one may admix an aluminum compound, a magnesium compound, a nickel compound, a cobalt compound, a titanium compound, a zirconium compound, a cerium compound and the like into the mixed powder. As the aluminum compound, there can be mentioned, for example, α-Al₂O₃, γ-Al₂O₃, AlOOH and Al(OH)₃. As the magnesium compound, there can be mentioned, for example, MgO, Mg(OH)₂ and MgCO₃. As the nickel compound, there can be mentioned, for example, NiO, Ni(OH)₂, and NiNO₃. As the cobalt compound, there can be mentioned, for example, CO₃O₄, CoO and Co(OH)₃. As the titanium compound, there can be mentioned, for example, TiO, TiO₂ and Ti₂O₃. As the zirconium compound, there can be mentioned, for example, ZrO₂, Zr(OH₄) and ZrO(NO₃)₂. As the cerium compound, there can be mentioned, for example, CeO₂. Ce(OH)₄ and Ce(NO₃)₃.

The mixed powder may further contain a grain growth-promoting agent as necessary. As the grain growth-promoting agent, there can be mentioned, for example, a flux agent such as NaCl, KCl or the like and a low-melting agent such as Bi₂O₃, PbO, Sb₂O₃, glass or the like. Of these, Bi₂O₃ is preferred. Also, the mixed powder may contain, for promotion of grain growth, a seed crystal composed of lithium manganate of spinel structure, as a nucleus of grain growth. Further, the seed crystal and the grain growth-promoting agent may be compounded therein. In this case, the grain growth-promoting agent may be added in a state that it is adhered to the seed crystal.

Incidentally, the mixed powder may be ground as necessary. The particle diameter of the mixed powder is preferably 10 μm or smaller; therefore, when it is larger than 10 μm, the mixed powder is preferably subjected to dry or wet grinding to make the particle diameter 10 μm or smaller. There is no particular restriction as to the method for grinding, and the grinding can be conducted with, for example, a pot mill, a beads mill, a hammer mill or a jet mill.

Next, the mixed powder prepared is subjected to forming, to produce a formed body. There is no particular restriction as to the shape of the formed body, and there can be mentioned, for example, a sheet shape, a hollow-granule shape, a scale shape, a honeycomb shape, a bar shape and a roll shape (a wound shape). In order to more effectively form crystal grains containing primary particles which have an average primary particle diameter of from 1 μm or larger to smaller than 5 μm and a non-octahedral shape, the formed body can be produced as, for example, a sheet-shaped formed body of 1.5 to 20 μm in thickness, a hollow granule having a shell thickness of 1.5 to 20 μm, a grain-shaped formed body of 1.5 to 20 μm in diameter, a scale-shaped formed body of 1.5 to 20 μm in thickness and 50 μm to 10 mm in size, a honeycomb-shaped formed body of 1.5 to 20 μm in partition wall thickness, a roll-shaped (wound) formed body of 1.5 to 20 μm in thickness, and a bar-shaped formed body of 1.5 to 20 μm in diameter. Of these, a sheet-shaped formed body of 1.5 to 20 μm in thickness is preferred.

The method for forming a sheet-shaped or scale-shaped formed body is not particularly restricted and the forming can be conducted, for example, by a doctor blade method, by a drum drier method in which a slurry of a mixed powder is coated on a hot drum and dried and then the resultant is scraped off using a scraper, by a disc drier method in which a slurry of a mixed powder is coated on a hot disc area and dried and then the resultant is scraped off using a scraper, or by an extrusion method in which a clay containing a mixed powder is extruded through a die with slits. Of these forming methods, there are preferred a doctor blade method and a drum dryer method, both capable of forming a uniform sheet-shaped or scale-shaped formed body.

The density of the formed body obtained by the above forming method may be increased by pressing with a roller or the like. Hollow granules can be produced by appropriately setting the conditions of spray dryer. As the method for producing a grain-shaped formed body (a bulk shaped formed body) of 1.5 to 20 μm in diameter, there can be mentioned, for example, a spray dry method, a method of pressing a mixed powder by a roller or the like, and a method of cutting an extruded formed body of bar-shaped or sheet-shaped. As the method for producing a honeycomb-shaped or bar-shaped formed body, there can be mentioned, for example, an extrusion method. Also, as the method for producing a roll-shaped formed body, there can be mentioned, for example, a drum dryer method.

The thickness of the sheet-shaped or scale-shaped formed body is preferably 1.5 to 20 μm, more preferably 2 to 10 μm, particularly preferably 3 to 6 μm. When the thickness of the formed body is larger than 20 μm, there are cases that, in the fired body obtained by firing, a large number of particles are connected in the thickness direction, making it difficult to obtain single particles by grinding. Meanwhile, when the thickness is smaller than 1.5 μm, an operational problem arises, reducing productivity in some cases.

Then, the formed body obtained is fired to obtain a fired body. There is no particular restriction as to the method for firing. When the sheet-shaped formed body is fired, the firing is preferably conducted by placing each sheet on a setter one by one so as to minimize the piling-up of sheets, or by placing crumpled sheets in a cover-opened sagger. Various firing conditions can be selected depending upon the use amount of grain growth-promoting agent or seed crystal and the atmosphere during firing. However, when the firing is conducted at high temperatures, a high cost is incurred and, therefore, its balance with effect is required to be considered. Also, depending upon the composition of the formed body, there may easily appear the oxygen defect which causes deterioration in battery properties (for example, Li_{1.02}Mn_{1.91}Al_{0.07}O₄). In this case, it is necessary to use the grain growth-promoting agent or the seed crystal in an increased amount and conduct firing at a lower temperature.

Specific firing conditions, when a positive electrode active material having a composition of Li_{1.1}Mn_{1.9}O₄ is produced, are preferably 0 to 0.5 mass % (the use amount of grain growth-promoting agent) and 860 to 1,050° C. (in the case of oxygen atmosphere) or 860 to 950° C. (in the case of air atmosphere). Also, when a positive electrode active material having a composition of Li_{1.08}Mn_{1.83}Al_{0.09}O₄ is produced, the firing conditions are preferably 0.01 to 1.0 mass % (the use amount of grain growth-promoting agent) and 860 to 1,050° C. (in the case of oxygen atmosphere) or 860 to 950° C. (in the case of airatmosphere). Further, when a positive electrode active material having a composition of Li_{1.02}Mn_{1.91}Al_{0.07}O₄ is produced, the firing conditions are preferably 0.01 to 1.0 mass % (the use amount of grain growth-promoting agent) and 800 to 1,050° C. (in the case of oxygen atmosphere) or 800 to 950° C. (in the case of air atmosphere). The oxygen partial pressure in oxygen atmosphere is preferred to be as high as possible and is preferably, for example, 50% or higher relative to the pressure of the atmosphere.

By conducting the firing with controlling the temperature-rising rate, the average primary particle diameter after firing can be uniformized. In this case, the temperature-rising rate may be, for example, 50 to 500° C. per hour. Also, by keeping the temperature in a low temperature range (keeping step) and then conducting the firing at the firing temperature, it is possible to grow primary particles uniformly. In this case, the low temperature range is about 400 to 800° C. when the material is fired, for example, at 900° C. The uniform growth of primary particles is also possible by forming crystal nuclei at a temperature (950 to 1,050° C.) higher than the firing temperature and then conducting the firing at a firing temperature (750 to 900° C.).

The firing can also be conducted in two stages. For example, a mixed powder of manganese oxide and alumina is formed into a sheet shape, the shaped formed body is fired, a lithium compound is added thereto, and firing is conducted again, whereby lithium manganate can be produced. Also, lithium manganate crystal of high lithium content is produced, then manganese oxide or alumina is added, and firing is conducted again, whereby lithium manganate of high capacity as well as low in defect can be produced.

It is presumed that the presence of grain growth-promoting agent and seed crystal in firing can show such an effect that the growth of primary particles are promoted even at relatively low temperatures (800 to 1,050° C.), thereby the high crystallinity is attained. By thus conducting the firing, there can be prepared lithium manganate of spinel structure as a polycrystal composed of primary particles relatively uniform in average primary particle diameter. Incidentally, in the firing of the sheet-shaped formed body, by conducting the grain growth sufficiently until one to ten particles are piled up in their thickness direction, there can be prepared a sheet-shaped fired body in which primary particles whose average primary particle diameter is roughly specified by the thickness of the sheet are connected approximately in a plane. Further, in this case, the grain growth in sheet thickness direction is restricted; grain growth in two-dimensional direction is promoted; as a result, a non-octahedral shape is easily formed, which is preferable. Furthermore, neighboring primary particles are connected closely to each other two-dimensionally and, when disintegration is conducted at particle boundaries to obtain single particles, the interfaces (the particle boundaries) are exposed; as a result, a non-octahedral shape is easily formed, which is preferable. Also, in the firing of a bulk shaped formed body, the growth of primary particles is restricted by the diameters (1.5 to 20 μm) of the particles constituting the bulk shaped formed body; therefore, a non-octahedral shape is easily formed. By the above operation, there can be formed a fired body in which the proportion of primary particles of non-octahedral shape is 70 areal % or larger.

Next, the fired body prepared is subjected to a disintegration treatment. As to the disintegration treatment, there is no particular restriction, and it can be conducted by passing the fired body through a mesh or a screen, or by using a ball mill, a vibration mill, a pot mill, a jet mill, a hammer mill, a pin mill, a pulverizer, an air grinder or the like. Of these, there is preferred a disintegration treatment by a pot mill using cobble stones of nylon, ZrO₂, Al₂O₃, glass, Si₃N₄, nylon-coated iron or the like.

By appropriately setting the disintegration method and conditions of the fired body, the disintegration can be conducted without impairment of crystallinity and in such an extent that grain boundaries disappear. Therefore, there can be easily obtained crystal grains in which the average primary particle diameter is uniform and the areal proportion of single particles is 40 areal % or larger, and the energy during disintegration is small; accordingly, there is no impairment of lattice strain, crystallite size, etc. Here, the disintegration method may be wet or dry. The disintegration conditions refer to conditions such as diameter of the cobble stones, number of revolutions, pot diameter, time, ratio amount of the powder and amount of the cobble stones, and the like.

After the disintegration treatment, a wet or dry classification treatment is conducted in some cases, in order to make more uniform the average primary particle diameter of the crystal grains whose average primary particle diameter is relatively uniform. As to the classification treatment, there is no particular restriction, but it can be conducted using a mesh, water elutriation, an air classifier, a sieve classifier, an elbow jet classifier or the like.

The intended powder obtained is subjected to a reheating treatment at 600 to 750° C. for 3 to 48 hours under the air or under the oxidation atmosphere. By the reheating treatment, oxygen defect is cured and there can be produced a positive electrode active material containing a large number of crystal grains which have an intended average primary particle diameter and wherein the areal proportion of single particles is 40 areal % or larger and the proportion of primary particles of non-octahedral shape is 70 areal % or larger. The reheating treatment may also be conducted before the disintegration treatment, that is, during the temperature lowering in the first firing, by maintaining the fired body at a desired temperature for a given period of time or by employing a slow temperature lowering rate, and this is effective for the cure of oxygen defect. In this case, when the fired body is a sheet-shaped or scale-shaped fired body in which primary particles are connected to each other approximately in a plane, as compared with when there is used a fired body in which primary particles are connected to each other three-dimensionally, the diffusion distance of oxygen atom is short and oxygen defect can be cured in a short time, which is preferable. When the reheating treatment is conducted after the disintegration treatment (or after the classification treatment), the powder after reheating treatment may be subjected again to disintegration and classification. The disintegration and the classification can be conducted by the above-mentioned methods, etc.

The positive electrode active material of the present invention can be produced by the above-mentioned production method. According to the production method, there can be prepared a large number of crystal grains (that is, a positive electrode active material powder) which have an average primary particle diameter of from 1 μm or lager to smaller than 5 μm and which contain single particles by 40 areal % or more and primary particles of non-octahedral shape by 70 areal % or more. Incidentally, in the large number of crystal grains prepared, the energy required in the disintegration is small and, accordingly, their lattice strain, crystallite size, etc. are not impaired and can be set in desired ranges; thus, the crystal grains are highly crystalline.

### (Properties)

The D₅₀/D_{BET} ratio of the median diameter D₅₀ (μm) and the D_{BET} (μm) calculated from the BET specific surface area by using the following general formula (1) is 1 to 4. When the D₅₀/D_{BET} ratio is larger than 4, aggregated particles are formed in a large amount, which may deteriorate the rate property.

D_{BET}=6/(d×S) (1)

[Wherein d is the true density (g/cm³) of the positive electrode active material powder and S is BET specific surface area (m²/g) in the general formula (1).]

Specifically, it can be calculated as follows. First, the particle diameter distribution of the positive electrode active material powder is measured using a laser diffraction particle size distribution analyzer (“LA-750” (trade name), a product of HORIBA) with water as a dispersing medium. There is determined, in the particle diameter distribution, a particle diameter D₅₀ in which the integrated mass value becomes 50%, that is, a median diameter (μm). Then, there is determined the surface area per unit mass of the positive electrode active material powder, that is, the BET specific surface area (m²/g) using a surface area measuring device (“Flowsorb II 2300” (trade name), a product of Shimadzu Corporation), by using nitrogen as an adsorption gas. The surface area per unit mass of the positive electrode active material powder is substituted into the general formula (1) to determine a D_{BET} (μm). A D₅₀/D_{BET} can be determined from the D₅₀ and the D_{BET}.

### II. Lithium Secondary Battery

The lithium secondary battery of the present invention has an electrode body which comprises a positive electrode containing the positive electrode active material described in “I. Positive electrode active material” and a negative electrode containing a negative electrode active material. The lithium secondary battery of the present invention is superior in cycle property at high temperatures. Such a property appears strikingly particularly in large-capacity seqondary batteries produced using a large amount of the electrode active material. Therefore, the lithium secondary battery of the present invention can be used preferably, for example, as an electric source for driving the motor of electric vehicle or hybrid electric vehicle. However, the lithium secondary battery of the present invention can also be used preferably as a small-capacity cell (e.g. coin cell).

The positive electrode can be obtained, for example, by mixing the positive electrode active material with acetylene black as a conductive agent, polyvinylidene fluoride (PVDF) as a binder, polytetrafluoroethylene (PTFE), etc. at given proportions to prepare a positive electrode material and coating the positive electrode material on the surface of metal foil or the like. As the positive electrode active material, there may be used lithium manganate of spinel structure alone, or a mixture thereof with a different active material [e.g. lithium nickelate, lithium cobaltate, lithium cobalt-nickel-manganate (i.e. ternary system) or iron lithium phosphate]. Lithium nickelate consumes the hydrofluoric acid which generates in the electrolytic solution of battery and which causes the dissolution of manganese (the dissolution is the main cause of durability deterioration of lithium manganate), and suppresses the dissolution of manganese effectively.

As the materials (other than the positive electrode active material) required as the components of the lithium secondary battery of the present invention, there can be used various known materials. As the negative electrode active material, there can be used, for example, an amorphous carbonaceous material (e.g. soft carbon or hard carbon), highly graphitized carbon material (e.g. artificial graphite or natural graphite) and acetylene black. Of these, a highly graphitized carbon material (which is high in lithium capacity) is used preferably. Using such a negative electrode active material, a negative electrode material is prepared; the negative electrode material is coated on a metal foil or the like; thereby, a negative electrode is obtained.

As the organic solvent used in the non-aqueous electrolytic solution, there can be preferably used a carbonic acid ester type solvent (e.g. ethylene carbonate (EC), diethyl carbonate (DEC), dimethyl carbonate (DMC) or propylene carbonate (PC)), a single solvent (e.g. γ-butyrolactone, tetrahydrofuran or acetonitrile), or a mixed solvent thereof.

As specific examples of the electrolyte, there can be mentioned a lithium complex fluoride compound (e.g. lithium phosphate hexafluoride (LiPF₆) or lithium borofluoride (LiBF₄)) and a lithium halide (e.g. lithium perchlorate (LiCl₄)). Ordinarily, at least one kind of such electrolyte is used by being dissolved in the above-mentioned organic solvent. Of these electrolytes, LiPF₆ is used preferably because it hardly causes oxidative decomposition and gives a high conductivity in non-aqueous electrolytic solution.

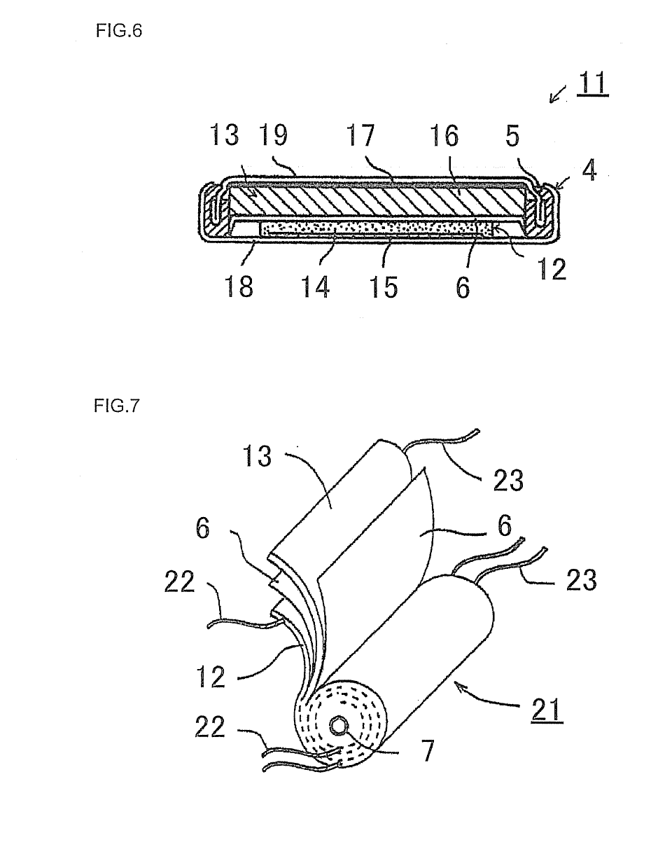

As specific examples of the battery structure, there can be mentioned a coin cell type lithium secondary battery (coin cell) 11 such as shown in FIG. 6, wherein an electrolytic solution is filled between a positive electrode plate 12 and a negative electrode plate 13 with a separator 6 provided between them; and a cylindrical lithium secondary battery such as shown in FIG. 7, using an electrode body 21 formed by winding or laminating, via a separator 6, a positive electrode plate 12 prepared by coating a positive electrode active material on a metal foil and a negative electrode 13 prepared by coating a negative electrode active material on a metal foil.

### EXAMPLES

The present invention is described specifically below by way of Examples. However, the present invention is in no way restricted to the following Examples. Incidentally, in the following Examples and Comparative Examples, “parts” and “%” are based on mass unless otherwise specified. The measurement methods of properties and the evaluation method of properties are shown below.

[Average Primary Particle Diameter (μm)]

First, a positive electrode active material powder was placed on a carbon tape so that there was no piling of particles, and Au was sputtered thereon in a thickness of about 10 nm using an ion sputtering apparatus (“JFC-1500” (trade name), a product of JEOL Ltd.). Then, the secondary electron image of primary particles was taken, using a scanning electron microscope (“JSM-6390” (trade name), a product of JEOL Ltd.), at such a magnification (e.g. a 1,000 to 10,000 magnification) that 20 to 50 primary particles were observed in the visual field. Here, there was calculated the average of the maximum diameter of the particle part not hidden by other particles and the largest diameter of the diameters at right angles to the above maximum diameter, and the average was taken as the particle diameter (μm) of primary particles. The average primary particle diameter was calculated by using the average of the particle diameters of all primary particles excluding the uncalculable particles having been obstructed by other particles and were uncalculable, of the image of the electron microscope. Incidentally, as to the diameter (μm) of primary particles, not only the diameter of the primary particles constituting single particles, but also the diameter of the primary particles constituting polycrystalline particles and aggregated particles were measured to use for the calculation of the average primary particle diameter. In FIG. 1 is shown an electron micrograph of an example of the positive electrode active material of the present invention.

### [Areal Proportion (Areal %) of Single Particles]

First, a positive electrode active material was mixed with a conductive resin (“Technovit 5000” (trade name), a product of Kulzer), followed by curing. Then, the cured material was subjected to mechanical polishing and then ion-polishing using a cross section polisher (“SM-09010” (trade name), a product of JEOL Ltd.). Thereafter, the back-scattered electron image of the resultant was taken, using a scanning electron microscope (“ULTRA 55” (trade name), a product of ZEISS), at such a magnification (e.g. a 1,000 to 10,000 magnification) that 20 to 50 primary particles were observed, and the cross section of the positive electrode active material was observed.

When the total length of all adhesion parts of a particle to which microparticles adhered was ⅕ or smaller relative to the round length of that particle estimated from the back-scattered electron image by using an image edit software (“Image-PRO” (trade name), a product of Media Cybernetics), the particle to which microparticles adhered was regarded as single particle. The areal proportion of single particles was calculated by measuring the area (B) occupied by all identifiable crystal grains and the area (b) occupied by all single particles each identified by as single particle, using the above-mentioned image edit software and subsequently substituting them into a formula of (b/B)×100.

### [Proportion (Areal %) of Primary Particles Having a Non-Octahedral Shape]

The area (A) occupied by all primary particles whose particle diameters and shapes could be evaluated and the area (a) occupied by primary particles of non-octahedral shape were measured using an image edit software (photoshop (trade name), a product of Adobe); they were substituted into an expression [(a/A)×100]; thereby, the proportion was calculated.

### [Crystallite Size (nm) and Value of the Lattice Strain (η)]

The powder X-ray diffraction pattern of a sample was obtained using “D8 ADVANCE” (a product of Bruker AXS) under the following conditions and analyzed according to the WPPD method to calculate the crystallite size and the value of the lattice strain of the sample.
X-ray output: 40 kV×40 mA
Goniometer radius: 250 mm
Divergence slit: 0.6°
Scattering slit: 0.6°
Receiving slit: 0.1 mm
Soller slit: 2.5° (incidence side, receiving side)
Measurement method: 2θ/θ method in a Focusing optical geometry of horizontally-placed sample type (2θ of 15 to 140° was measured, step width of 0.01°)
Scanning time Set so that the intensity of main peak [(111) face] became about 10,000 counts.

The specific analytical procedure is described below. The crystallite size (nm) and the value of the lattice strain (η) obtained by other analytical procedure may be different from the crystallite size (nm) and the value of the lattice strain (η) obtained by the present analytical procedure; however, they are not excluded from the scope of the present invention. In the present invention, the evaluation of the crystallite size and the value of the lattice strain should be made using the crystallite size (nm) and the value of the lattice strain (η) obtained by the present analytical procedure.

1. Start of software (TOPAS) and load of measured data
2. Setting of emission profile (selection of Cu tube and Bragg-Brentano type focusing optical geometry)
3. Setting of background (Legendre polynominal is used as profile function, and the number of terms is set at 8 to 20.)
4. Setting of instrument (fundamental parameter is used, and slit conditions, filament length and sample length are input.)
5. Setting of corrections (sample displacement is used. When the density of sample filled in sample holder is low, absorption is used as well. In this case, absorption is set at the linear absorption coefficient of sample.)
6. Setting of crystal structure (space group is set at F-d3m; lattice constant, crystallite size and lattice strain are used; and the spread of profile by crystallite size and lattice strain is set as Lorenz function.)
7. Calculation (background, sample displacement, diffraction intensity, lattice constant, crystallite size and lattice strain are made precise.)
8. Analysis is over when the standard deviation of crystallite size is 6% or smaller of the crystallite size which has been made precise. When the standard deviation is larger than 6%, moves to the following procedure.
9. The spread of profile by lattice strain is set as Gauss function (the setting of the crystallite size as Lorenz function is unchanged.)
10. Calculation (background, sample displacement, diffraction intensity, lattice constant, crystallite size and lattice strain are made precise.)
11. Analysis is over when the standard deviation of crystallite size is 6% or smaller of the crystallite size which has been made precise. When the standard deviation is larger than 6%, analysis is impossible.
12. The lattice strain obtained is multiplied by π/180, and the value is taken as η.

### [D₅₀/D_{BET}]

Calculated from the median diameter D₅₀ (μm) and the D_{BET} (μm) calculated from the BET specific surface area using the general formula (1), both of a sample.

[Median Diameter D₅₀ (μm)]

First; the particle diameter distribution of a positive electrode active material powder was measured using a laser diffraction particle size distribution analyzer (“LA-750” (trade name), a product of HORIBA, Ltd.) with water as a dispersing medium. There was determined, in the particle diameter distribution, a particle diameter D₅₀ in which the integrated mass value became 50%, that is, a median diameter (μm).

[D_{BET} (μm)]

There was determined the surface area per unit mass of a positive electrode active material powder, that is, the BET specific surface area (m²/g) using a specific surface measuring device (“Flowsorb II 2300” (trade name), a product of Shimadzu Corporation), by using nitrogen as an adsorption gas. The surface area per unit mass of the positive electrode active material powder was substituted into the general formula (1) to determine a D_{BET} (μm).

D_{BET}=6/(d×S) (1)

[Wherein d is the true density (g/cm³) of a positive electrode active material powder and S is BET specific surface area (m²/g) in the general formula (1).]

### [Rate Property (%)]

At a test temperature of 20° C., constant-current charge was conducted at a current of 0.1 C rate until the battery voltage became 4.3 V, and constant-voltage charge was conducted at a current condition of keeping the battery voltage at 4.3 V until the current decreased to 1/20. Then, a halt of 10 minutes was conducted. Subsequently, constant-current discharge was conducted at a current of 1 C rate until the battery voltage became 3.0 V. Then, a halt of 10 minutes was conducted. This charge-discharge operation was taken as 1 cycle. Total 3 cycles were repeated at 20° C. A discharge capacity at the 3rd cycle was measured and taken as discharge capacity C_{(1C)}. Next, at a test temperature of 20° C., constant-current charge was conducted at a current of 0.1 C rate until the battery voltage became 4.3 V, and constant-voltage charge was conducted at a current condition of keeping the battery, voltage at 4.3 V until the current decreased to 1/20. Then, a halt of 10 minutes was conducted. Subsequently, constant-current discharge was conducted at a current of 10 C rate until the battery voltage became 3.0 V. Then, a halt of 10 minutes was conducted. This charge-discharge operation was taken as 1 cycle. Total 3 cycles were repeated at 20° C. A discharge capacity at the 3rd cycle was measured and taken as discharge capacity C_{(10C)}. The capacity retention rate (%) of the discharge capacity C_{(10C)} at 10 C rate to the discharge capacity C_{(10C)} at 1 C rate was calculated and taken as rate property.

### [Cycle Property (%)]

At a test temperature of 60° C., charge was conducted at a constant current and a constant voltage of 10 rate until the battery voltage became 4.3 V, and discharge was conducted at a constant current of 10 rate until the battery voltage became 3.0 V. This was taken as 1 cycle. 100 cycles of charge-discharge were repeated. Thereafter, the discharge capacity of the battery was divided by the initial capacity and the quotient (expressed in %) was taken as cycle property.

### [Bi Content]

Measured using an ICP (inductively coupled plasma) optical emission spectrometer. Specifically explaining, a sample solution prepared by adding hydrochloric acid to crystal grains and decomposing the mixture under pressure was placed in an ICP optical emission spectrometer [“ULTIMA 2” (trade name), a product of HORIBA, Ltd.] to quantitatively determine Li, Mn and Bi, and the bismuth contained in bismuth compound relative to the manganese contained in lithium manganate was calculated based on the determination results.

### [Zr Content]

Measured using an ICP (inductively coupled plasma) optical emission spectrometer. Specifically explaining, a sample solution prepared by adding hydrochloric acid to crystal grains and decomposing the mixture under pressure was placed in an ICP optical emission spectrometer [“ULTIMA 2” (trade name), a product of HORIBA, Ltd.] to quantitatively determine Li, Mn and Zr, and the zirconium contained in zirconium compound relative to the manganese contained in lithium manganate was calculated based on the determination results.

### Examples 1 to 4

### Production of Positive Electrode Active Materials

### Raw Material Preparation Step

There were weighed a Li₂CO₃ powder (a product of The Honjo Chemical Corporation, fine grade, average particle diameter: 3 μm), a MnO₂ powder (a product of Tosoh Corporation, electrolytic manganese dioxide, FM grade, average particle diameter: 5 μm, purity: 95%) (the two powders were weighed so as to give a chemical formula of Li_{1.1}Mn_{1.9}O₄), and a Bi₂O₃ powder (particle diameter: 0.3 μm, a product of Taiyo Koko Co., Ltd) (this powder was weighed so that the mass proportion (%) to MnO₂ became as shown in Table 1). 100 parts of these powders and 100 parts of an organic solvent as a dispersing medium (a mixed solvent of equal volumes of toluene and isopropyl alcohol) were placed in a cylindrical, wide-mouthed bottle made of a synthetic resin and subjected to wet mixing and grinding for 16 hours with ball mill containing zirconia balls of 5 mm in diameter, to obtain a mixed powder.

### Sheet Formation Step

10 parts of a polyvinyl butyral as a binder (“S-LEC BM-2” (trade name), a product of Sekisui Chemical Co., Ltd.), 4 parts of a plasticizer (“DOP” (trade name), a product of Kurogane Kasei Co., Ltd.) and 2 parts of a dispersing agent (“RHEODOL SP-O 30” (trade name), a product of Kao Corporation) were added to the mixed powder, followed by mixing, thereby a forming material of slurry state was obtained. The forming material of slurry state was degassed under vacuum with stirring, to adjust the slurry viscosity to 500 to 4,000 mPa·s. The viscosity-adjusted forming material of slurry state was spread on a PET film by doctor blade method, to obtain each sheet-shaped formed body. Incidentally, the thickness of each green sheet is shown in Table 1.

### Firing Step

The sheet-shaped formed body was peeled off from the PET film, cut into a 300 mm×300 mm size using a cutter, and placed in an alumina-made sagger (dimension: 90 mm×90 mm×60 mm (height)) in a crumpled state. Then, debinder was conducted at 600° C. for 2 hours in a cover-opened state (that is, under the air) or under the oxygen atmosphere, after that firing was conducted at a temperature shown in Table 1, for a time shown in Table 1.

### Disintegration Step

The sheet-shaped formed body after firing was subjected to disintegration using a pot mill, under the conditions shown in Table 1.

### Reheating Treatment Step

The powder after disintegration was reheated treatment under the air or under the oxygen atmosphere at 600 to 750° C. for 3 to 48 hours to produce each positive electrode active material.

### Comparative Examples 1 to 3

### Production of Positive Electrode Active Materials

Positive electrode active materials were produced in the same manner as in Examples 1 to 4 except that, in the raw material preparation step, the conditions shown in Table 1 were employed.

In Table 1 are shown the addition amount of bismuth compound, the thickness of each green sheet, the conditions of firing step, the conditions of disintegration step and the properties of the powder (positive electrode active material) obtained, in each of Examples 1 to 4 and Comparative Examples 1 to 3.

TABLE 1

| | Formation step | | | | | | | |
|---|---|---|---|---|---|---|---|---|
| | Addition | Thickness | | | | | | |
| | amount of Bi | of each | | | | Disintegration step | | |
| | compound | green sheet | Firing conditions | | | Grinding | | |
| | (mass %) | (μm) | Atmosphere | Temp. (° C.) | Time (hr) | ball | Method | Time (hr) |
| Ex. 1 | 0.5 | 15 | Oxygen | 1000 | 1 | Nylon | Wet | 10 |
| Ex. 2 | 0.01 | 10 | Air | 950 | 12 | Nylon | Wet | 20 |
| Ex. 3 | 0.005 | 10 | Air | 900 | 16 | Nylon | Wet | 40 |
| Ex. 4 | 0.002 | 5 | Air | 860 | 36 | ZrO₂ | Wet | 1 |
| Comp. | 0 | 10 | Air | 800 | 3 | ZrO₂ | Wet | 10 |
| Ex. 1 | | | | | | | | |
| Comp. | 0.01 | 25 | Oxygen | 900 | 16 | Nylon | Wet | 10 |
| Ex. 2 | | | | | | | | |
| Comp. | 0 | 10 | Air | 800 | 3 | ZrO₂ | Wet | 2 |
| Ex. 3 | | | | | | | | |

| | Properties of positive electrode active material | | | | | | | |
|---|---|---|---|---|---|---|---|---|
| | Average | | | | | Proportion of | | |
| | primary | | | Value of | Proportion | primary particles | | |
| | particle | | | lattice | of single | of non- | | |
| | diameter | D₅₀/D_{BRT} | Crystallite | strain | particles | octahedral shape | Bi | Zr |
| | (μm) | ratio | size (nm) | (×10⁻³) | (areal %) | (areal %) | content | content |
| Ex. 1 | 4.5 | 2.3 | 1000 | 0.1 | 30 | 60 | 10 ppm | 100 ppm |
| Ex. 2 | 2.5 | 3.7 | 900 | 0.5 | 40 | 60 | 10 ppm | 100 ppm |
| Ex. 3 | 2 | 2.3 | 900 | 0.5 | 40 | 70 | 20 ppm | 100 ppm |
| Ex. 4 | 1.2 | 2.6 | 500 | 0.7 | 70 | 90 | 10 ppm | 150 ppm |
| Comp. | 0.9 | 1.8 | 550 | 0.85 | 30 | 60 | 0 | 500 ppm |
| Ex. 1 | | | | | | | | |
| Comp. | 2.2 | 4.3 | 850 | 0.15 | 30 | 60 | 20 ppm | 100 ppm |
| Ex. 2 | | | | | | | | |
| Comp. | 1 | 2.8 | 450 | 1 | 30 | 60 | 0 | 200 ppm |
| Ex. 3 | | | | | | | | |

### Examples 5 to 8 and Comparative Examples 4 to 6

### Production of Positive Electrode Active Materials

### Raw Material Preparation Step

There were weighed a Li₂CO₃ powder (a product of The Honjo Chemical Corporation, fine grade, average particle diameter: 3 μm), a MnO₂ powder (a product of Tosoh Corporation, electrolytic manganese dioxide, FM grade, average particle diameter: 5 μm, purity: 95%), an Al(OH)₃ powder (H-43M (trade name) (a product of Showa Denko K.K., average particle diameter: 0.8 μm) (these three powders were weighed so as to give a chemical formula of Li_{1.08}Mn_{1.83} Al_{0.09}O₄), and a Bi₂O₃ powder (particle diameter: 0.3 μm, a product of Taiyo Koko Co., Ltd) (this powder was weighed so that the mass proportion (%) to MnO₂ became as shown in Table 2). 100 parts of these powders and 100 parts of an organic solvent as a dispersing medium (a mixed solvent of equal volumes of toluene and isopropyl alcohol) were placed in a cylindrical, wide-mouthed bottle made of a synthetic resin and subjected to wet mixing and grinding for 16 hours with a ball mill containing zirconia balls of 5 mm in diameter, to obtain a mixed powder.

Sheet formation step to reheating treatment step were conducted in the same manner as in Examples 1 to 4 to produce positive electrode active materials. In Table 2 are shown the addition amount of bismuth compound, the thickness of each green sheet, the conditions of firing step, the conditions of disintegration step and the properties of the powder (positive electrode active material) obtained, in each of Examples 5 to 8 and Comparative Examples 4 to 6.

TABLE 2

| | Formation step | | | | | | | |
|---|---|---|---|---|---|---|---|---|
| | Addition | Thickness | | | | | | |
| | amount of Bi | of each | | | | Disintegration step | | |
| | compound | green sheet | Firing conditions | | | Grinding | | |
| | (mass %) | (μm) | Atmosphere | Temp. (° C.) | Time (hr) | ball | Method | Time (hr) |
| Ex. 5 | 0.25 | 15 | Air | 900 | 16 | Nylon | Wet | 20 |
| Ex. 6 | 0.5 | 10 | Oxygen | 1000 | 1 | Nylon | Wet | 40 |
| Ex. 7 | 0.1 | 10 | Air | 900 | 12 | Nylon | Dry | 5 |
| Ex. 8 | 0.1 | 5 | Air | 900 | 12 | Nylon | Dry | 10 |
| Comp. | 0 | 5 | Air | 900 | 12 | Nylon | Wet | 5 |
| Ex. 4 | | | | | | | | |
| Comp. | 0.25 | 25 | Air | 900 | 20 | Nylon | Wet | 40 |
| Ex. 5 | | | | | | | | |
| Comp. | 0.1 | 10 | Air | 800 | 3 | ZrO₂ | Wet | 2 |
| Ex. 6 | | | | | | | | |

| | Properties of positive electrode active material | | | | | | | |
|---|---|---|---|---|---|---|---|---|
| | Average | | | | | Proportion of | | |
| | primary | | | Value of | Proportion | primary particles | | |
| | particle | | | lattice | of single | of non- | | |
| | diameter | D₅₀/D_{BRT} | Crystallite | strain | particles | octahedral shape | Bi | Zr |
| | (μm) | ratio | size (nm) | (×10⁻³) | (areal %) | (areal %) | content | content |
| Ex. 5 | 4 | 2.2 | 1300 | 0.06 | 30 | 60 | 10 ppm | 100 ppm |
| Ex. 6 | 4 | 2.3 | 850 | 0.45 | 40 | 60 | 10 ppm | 100 ppm |
| Ex. 7 | 2 | 1.9 | 800 | 0.5 | 40 | 70 | 10 ppm | 100 ppm |
| Ex. 8 | 2 | 2.3 | 800 | 0.5 | 80 | 80 | 10 ppm | 100 ppm |
| Comp. | 0.8 | 1.7 | 500 | 0.9 | 30 | 60 | 0 | 100 ppm |
| Ex. 4 | | | | | | | | |
| Comp. | 4 | 4.2 | 850 | 0.45 | 30 | 60 | 10 ppm | 100 ppm |
| Ex. 5 | | | | | | | | |
| Comp. | 1 | 2.2 | 450 | 1 | 30 | 60 | 10 ppm | 200 ppm |
| Ex. 6 | | | | | | | | |

### Examples 9 to 12 and Comparative Examples 7 to 9

### Production of Positive Electrode Active Materials

### Raw Material Preparation Step

There were weighed a Li₂CO₃ powder (a product of The Honjo Chemical Corporation, fine grade, average particle diameter: 3 μm), a MnO₂ powder (a product of Tosoh Corporation, electrolytic manganese dioxide, FM grade, average particle diameter: 5 μm, purity: 95%), an Al(OH)₃ powder (H-43M (trade name) (a product of Showa Denko K.K., average particle diameter: 0.8 μm) (these three powders were weighed so as to give a chemical formula of Li_{1.02}Mn_{1.91} Al_{0.07}O₄), and a Bi₂O₃ powder (particle diameter: 0.3 μm, a product of Taiyo Koko Co., Ltd) (this powder was weighed so that the mass proportion (%) to MnO₂ became as shown in Table 3). 100 parts of these powders and 100 parts of an organic solvent as a dispersing medium (a mixed solvent of equal volumes of toluene and isopropyl alcohol) were placed in a cylindrical, wide-mouthed bottle made of a synthetic resin and subjected to wet mixing and grinding for 16 hours with a ball mill containing zirconia balls of 5 mm in diameter, to obtain a mixed powder.

Sheet formation step to reheating step were conducted in the same manner as in Examples 1 to 4 to produce positive electrode active materials. In Table 3 are shown the addition amount of bismuth compound, the thickness of each green sheet, the conditions of firing step, the conditions of disintegration step and the properties of the powder (positive electrode active material) obtained, in each of Examples 9 to 12 and Comparative Examples 7 to 9.

TABLE 3

| | Formation step | | | | | | | |
|---|---|---|---|---|---|---|---|---|
| | Addition | Thickness | | | | | | |
| | amount of Bi | of each | | | | Disintegration step | | |
| | compound | green sheet | Firing conditions | | | Grinding | | |
| | (mass %) | (μm) | Atmosphere | Temp. (° C.) | Time (hr) | ball | Method | Time (hr) |
| Ex. 9 | 0.5 | 15 | Air | 800 | 48 | Nylon | Wet | 40 |
| Ex. 10 | 0.75 | 10 | Oxygen | 800 | 60 | Nylon | Wet | 10 |
| Ex. 11 | 0.25 | 10 | Air | 850 | 12 | Si₃N₄ | Wet | 5 |
| Ex. 12 | 1 | 5 | Oxygen | 800 | 16 | Nylon | Wet | 20 |
| Comp. | 0.1 | 5 | Air | 800 | 16 | Nylon | Dry | 10 |
| Ex. 7 | | | | | | | | |
| Comp. | 0.75 | 10 | Oxygen | 800 | 60 | Nylon | Wet | 2 |
| Ex. 8 | | | | | | | | |
| Comp. | 0.1 | 3 | Air | 800 | 3 | ZrO₂ | Wet | 2 |
| Ex. 9 | | | | | | | | |

| | Properties of positive electrode active material | | | | | | | |
|---|---|---|---|---|---|---|---|---|
| | Average | | | | | Proportion of | | |
| | primary | | | Value of | Proportion | primary particles | | |
| | particle | | | lattice | of single | of non- | | |
| | diameter | D₅₀/D_{BRT} | Crystallite | strain | particles | octahedral shape | Bi | Zr |
| | (μm) | ratio | size (nm) | (×10⁻³) | (areal %) | (areal %) | content | content |
| Ex. 9 | 1.5 | 3.2 | 700 | 0.8 | 30 | 60 | 0.4 wt % | 100 ppm |
| Ex. 10 | 2 | 1.7 | 1000 | 0.1 | 40 | 60 | 0.5 wt % | 100 ppm |
| Ex. 11 | 4.5 | 2.0 | 600 | 0.9 | 40 | 70 | 0.1 wt % | 100 ppm |
| Ex. 12 | 1 | 2.6 | 650 | 0.3 | 50 | 80 | 0.8 wt % | 100 ppm |
| Comp. | 0.9 | 2.0 | 700 | 0.4 | 30 | 60 | 200 ppm | 100 ppm |
| Ex. 7 | | | | | | | | |
| Comp. | 2 | 4.3 | 850 | 0.15 | 30 | 60 | 0.5 wt % | 100 ppm |
| Ex. 8 | | | | | | | | |
| Comp. | 1 | 3.4 | 450 | 1 | 30 | 60 | 200 ppm | 200 ppm |
| Ex. 9 | | | | | | | | |

### Examples 13 to 16 and Comparative Examples 10 to 12

### Production of Lithium Secondary Batteries

FIG. 6 is a sectional view showing an embodiment of the lithium secondary battery of the present invention. In FIG. 6, a lithium secondary battery (coin cell) 11 was produced by laminating a positive electrode collector 15, a positive electrode layer 14, a separator 6, a negative electrode layer 16 and a negative electrode collector 17 in this order, and encapsulating the resulting laminate and an electrolyte in a battery case 4 (containing a positive electrode side container 18, a negative electrode side container 19 and an insulation gasket 5) in liquid tight.

Specifically explaining, there were mixed 5 mg of each of the positive electrode active materials produced in Examples 1 to 4 and Comparative Examples 1 to 3, acetylene black as a conductive agent and a polytetrafluoroethylene (PTFE) as a binder at a mass ratio of 5:5:1, to produce each positive electrode material. The positive electrode material produced was placed on an Al mesh of 15 mm in diameter and press-molded into a disc using a press at a force of 10 kN, to produce each positive electrode layer 14.

Then, each lithium secondary battery (coin cell) 11 was produced using the above-produced positive electrode layer 14, an electrolytic solution prepared by dissolving LiPF₆ in an organic solvent consisting of equal volumes of ethylene carbonate (EC) and diethyl carbonate (DEC), so as to give a LiPF₆ concentration of 1 mol/L, a negative electrode layer 16 made of a Li plate, a negative electrode collector 17 made of a stainless steel plate, and a polyethylene film-made separator 6 having lithium ion permeability. By using each lithium secondary battery (coin cell) 11 produced, rate property and cycle property were evaluated. The evaluation results are shown in Table 4.

TABLE 4

| | Kinds of positive | | |
|---|---|---|---|
| | electrode active | Rate property | Cycle property |
| | material | (%) | (%) |
| Example 13 | Example 1 | 93 | 96 |
| Example 14 | Example 2 | 95 | 96 |
| Example 15 | Example 3 | 97 | 95 |
| Example 16 | Example 4 | 99 | 95 |
| Comparative | Comparative | 88 | 93 |
| Example 10 | Example 1 | | |
| Comparative | Comparative | 85 | 95 |
| Example 11 | Example 2 | | |
| Comparative | Comparative | 88 | 88 |
| Example 12 | Example 3 | | |

The followings are clear from Table 4. By using the positive electrode active materials of Examples 1 to 4, there can be produced lithium secondary batteries improved in cycle property and superior in rate property (Examples 13 to 16). When there are used the positive electrode active material wherein the areal proportion of single particles are 40 areal % or more (Example 2) and wherein the areal proportion of single particles are 40 areal % or more as well as the proportion of primary particles having a non-octahedral shape is 70% or more (Examples 3 to 4), the rate property and the cycle property are particularly superior (Examples 14 to 16). Meanwhile, when there are used the positive electrode active material having an average primary particle diameter of smaller than 1 μm (Comparative Example 1), the Positive electrode active material having a D₅₀/D_{BET} ratio of larger than 4 (Comparative Example 2), and the positive electrode active material having crystallite sizes of smaller than 500 nm and the value of a lattice strain (η) of larger than 0.9×10⁻³ (Comparative Example 3), at least either of the rate property and the cycle property is deteriorated (Comparative Examples 10 to 12).

### Examples 17 to 20 and Comparative Examples 13 to 15

### Production of Lithium Secondary Batteries

Lithium secondary batteries were produced in the same manner as in Examples 13 to 16 and Comparative Examples 10 to 12 except that there were used the positive electrode active materials produced in Examples 5 to 8 and Comparative Examples 4 to 6. By using each lithium secondary battery produced, rate property and cycle property were evaluated. The evaluation results are shown in Table 5.

TABLE 5

| | Kinds of positive | | |
|---|---|---|---|
| | electrode active | Rate property | Cycle property |
| | material | (%) | (%) |
| Example 17 | Example 5 | 92 | 97 |
| Example 18 | Example 6 | 94 | 97 |
| Example 19 | Example 7 | 96 | 96 |
| Example 20 | Example 8 | 98 | 96 |
| Comparative | Comparative | 86 | 94 |
| Example 13 | Example 4 | | |
| Comparative | Comparative | 82 | 96 |
| Example 14 | Example 5 | | |
| Comparative | Comparative | 85 | 88 |
| Example 15 | Example 6 | | |

The followings are clear from Table 5. By using the positive electrode active materials of Examples 5 to 8, there can be produced lithium secondary batteries improved in cycle property and superior in rate property (Examples 17 to 20). When there are used the positive electrode active material wherein the areal proportion of single particles are 40 areal % or more (Example 6) and wherein the areal proportion of single particles are 40 areal % or more as well as the proportion of primary particles having a non-octahedral shape is 70% or more (Examples 7 to 8), the rate property and the cycle property are particularly superior (Examples 18 to 20). Meanwhile, when there are used the positive electrode active material having an average primary particle diameter of smaller than 1 μm (Comparative Example 4), the positive electrode active material having a D₅₀/D_{BET} ratio of larger than 4 (Comparative Example 5), and the positive electrode active material having crystallite sizes of smaller than 500 nm and the value of a lattice strain (η) of larger than 0.9×10⁻³ (Comparative Example 6), at least either of the rate property and the cycle property is deteriorated (Comparative Examples 13 to 15).

### Examples 21 to 24 and Comparative Examples 16 to 18

### Production of Lithium Secondary Batteries

Lithium secondary batteries were produced in the same manner as in Examples 13 to 16 and Comparative Examples 10 to 12 except that there were used the positive electrode active materials produced in Examples 9 to 12 and Comparative Examples 7 to 9. By using each lithium secondary battery produced, rate property and cycle property were evaluated. The evaluation results are shown in Table 6.

TABLE 6

| | Kinds of positive | | |
|---|---|---|---|
| | electrode active | Rate property | Cycle property |
| | material | (%) | (%) |
| Example 21 | Example 9 | 92 | 96 |
| Example 22 | Example 10 | 94 | 96 |
| Example 23 | Example 11 | 95 | 95 |
| Example 24 | Example 12 | 97 | 95 |
| Comparative | Comparative | 80 | 95 |
| Example 16 | Example 7 | | |
| Comparative | Comparative | 83 | 95 |
| Example 17 | Example 8 | | |
| Comparative | Comparative | 85 | 85 |
| Example 18 | Example 9 | | |

The followings are clear from Table 6. By using the positive electrode active materials of Examples 9 to 12, there can be produced lithium secondary batteries improved in cycle property and superior in rate property (Examples 21 to 24). When there are used the positive electrode active material wherein the areal proportion of single particles are 40 areal % or more (Example 10) and wherein the areal proportion of single particles are 40 areal % or more as well as the proportion of primary particles having a non-octahedral shape is 70% or more (Examples 11 to 12), the rate property and the cycle property are particularly superior (Examples 22 to 24). Meanwhile, when there are used the positive electrode active material having an average primary particle diameter of smaller than 1 μm (Comparative Example 7), the positive electrode active material having a D₅₀/D_{BET} ratio of larger than 4 (Comparative Example 8), and the positive electrode active material having crystallite sizes of smaller than 500 nm and the value of a lattice strain (η) of larger than 0.9×10⁻³ (Comparative Example 9), at least either of the rate property and the cycle property is deteriorated (Comparative Examples 16 to 18).

### INDUSTRIAL APPLICABILITY

The positive electrode active material of the present invention is usable for production of a lithium secondary battery superior in high-temperature cycle property. Therefore, its use in batteries for driving of hybrid electric vehicles, electric apparatuses, communication apparatuses, etc. can be expected.

### EXPLANATION OF NUMERICAL SYMBOLS

4: a battery case, 5: an insulation gasket, 6: a separator, 7: a core, 11: a lithium secondary battery, 12: a positive electrode plate, 13: a negative electrode plate, 14: a positive electrode layer, 15: a positive electrode collector, 16: a negative electrode layer, 17: a negative electrode collector, 18: a positive electrode side container, 19: a negative electrode side container, 21: an electrode body, 22: a tab for positive electrode, 23: a tab for negative electrode, 31, 32, 41, 42, 43: each a primary particle, 51: a microparticle, and 61: a Cu powder

1. A positive electrode active material containing a large number of crystal grains which are composed of lithium manganate of spinel structure containing lithium and manganese as the constituent elements, which have an average primary particle diameter of from 1 μm or larger to smaller than 5 μm, which have a crystallite size of 500 to 1,500 nm in powder X-ray diffraction pattern, which have a value of a lattice strain (η) of 0.05×10⁻³ to 0.9×10⁻³, and
having a D₅₀/D_{BET} ratio of 1 to 4 wherein the D₅₀ (μm) is the median diameter of the positive electrode active material and the D_{BET} (μm) is calculated from the BET specific surface area by using the following general formula (1).
D_{BET}=6/(d×S) (1)
[Wherein d is the true density (g/cm³) of the positive electrode active material powder and S is BET specific surface area (m²/g) in the general formula (1).]

2. A positive electrode active material according to claim 1, wherein the crystal grains contain single particles by 40 areal % or more.

3. A positive electrode active material according to claim 1, wherein the crystal grains contain primary particles of non-octahedral shape by 70 areal % or more.

4. A positive electrode active material according to claim 2, wherein the crystal grains contain primary particles of non-octahedral shape by 70 areal % or more.

5. A positive electrode active material according to claim 1, which further contains a bismuth compound containing bismuth.

6. A positive electrode active material according to claim 1, which further contains a zirconium compound containing zirconium.

7. A positive electrode active material according to claim 5, which further contains a zirconium compound containing zirconium.

8. A lithium secondary battery which has an electrode body comprising a positive electrode containing a positive electrode active material according to claim 1 and a negative electrode containing a negative electrode active material.

9. A lithium secondary battery which has an electrode body comprising a positive electrode containing a positive electrode active material according to claim 2 and a negative electrode containing a negative electrode active material.

10. A lithium secondary battery which has an electrode body comprising a positive electrode containing a positive electrode active material according to claim 3 and a negative electrode containing a negative electrode active material.

11. A lithium secondary battery which has an electrode body comprising a positive electrode containing a positive electrode active material according to claim 4 and a negative electrode containing a negative electrode active material.
